(19) United States
(12) Patent Application Publication
(10) Pub. No.: US 2014/0149563 A1
(43) Pub. Date: May 29, 2014

(54) DATA PROCESSING SYSTEM, METHOD OF DATA PROCESSING, AND DATA PROCESSING APPARATUS

(71) Applicant: Takayuki ONO, Tokyo (JP)

(72) Inventor: Takayuki ONO, Tokyo (JP)

(73) Assignee: RICOH COMPANY, LTD., Tokyo (JP)

(21) Appl. No.: 14/060,788

(22) Filed: Oct. 23, 2013

(30) Foreign Application Priority Data
Nov. 26, 2012 (JP) 2012-257478

(51) Int. Cl. H04L 12/24

(52) U.S. Cl. CPC H04L 41/0806
USPC 709/222

(57) ABSTRACT

A data processing system includes a first storage unit that stores setting information of each device; a second storage unit that stores information indicating a working condition of a plurality of devices; an obtaining unit that obtains setting information of a first device for which information indicating that the device is not used is stored in the second storage unit, from the first storage unit; and a setting unit that sets the obtained setting information for a second device.

### BACKGROUND OF THE INVENTION

1. Field of the Invention

The present invention relates to a data processing system, a method of data processing and a data processing apparatus.

2. Description of the Related Art

In companies, devices such as multiple function processing machines, printers or the like are sometimes substituted by new devices. In other words, previous devices are disposed and newly purchased devices are used instead.

In recent electronic devices such as multiple function processing machines, printers or the like, capabilities can be expanded in accordance with operations of users by altering values of various setting items, installing application programs, or the like.

When such devices are substituted by new ones, there may be a case for users to wish to continuously use capabilities that were usable for the previous devices, for newly introduced (installed) devices. In such a case, the users have to repeat the same operations such as a setting operation, an installing operation or the like performed for the previous devices, for the newly introduced devices.

Such operations are large burden, in particular, for the users having a large number of devices.

### PATENT DOCUMENT

[Patent Document 1] Japanese Laid-open Patent Publication No. 2012-084124

### SUMMARY OF THE INVENTION

The present invention is made in light of the above problems, and provides a technique to effectively perform a setting operation for a device.

According to an embodiment, there is provided a data processing system including a first storage unit that stores setting information of each device; a second storage unit that stores information indicating a working condition of a plurality of devices; an obtaining unit that obtains setting information of a first device for which information indicating that the device is not used is stored in the second storage unit, from the first storage unit; and a setting unit that sets the obtained setting information for a second device.

According to another embodiment, there is provided a method of data processing performed by a computer connected to a storage device that stores information indicating a working condition of each device via a network, including: an obtaining step of obtaining setting information of a first device for which information indicating that the device is not used is stored in the storage device from a storage unit that stores setting information of a plurality of devices; and a setting step of setting the obtained setting information for a second device.

According to another embodiment, there is provided a non-transitory computer-readable recording medium having recorded thereon a program that causes a computer connected to a storage device that stores information indicating a working condition of each device via a network, to execute steps including: an obtaining step of obtaining setting information of a first device for which information indicating that the device is not used is stored in the storage device from a storage unit that stores setting information of a plurality of devices; and a setting step of setting the obtained setting information for a second device.

Note that also arbitrary combinations of the above-described elements, and any changes of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a view illustrating an example of a system structure of an embodiment;

FIG. 2 is a view illustrating an example of a hardware structure of a device management apparatus of the embodiment;

FIG. 3 is a view illustrating an example of a functional structure of each apparatus of the embodiment;

FIG. 4 is a flowchart for explaining an example of process steps performed by the device management apparatus and a resource management apparatus in the embodiment;

FIG. 5 is a view illustrating an example of a new device registration screen;

FIG. 6 is a view illustrating an example of a structure of resource information;

FIG. 7 is a view illustrating an example of a structure of device information;

FIG. 8 is a view illustrating an example of a substitution condition setting screen; and

FIG. 9 is a flowchart for explaining an example of process steps performed by the device management apparatus and a resource management apparatus in another embodiment.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

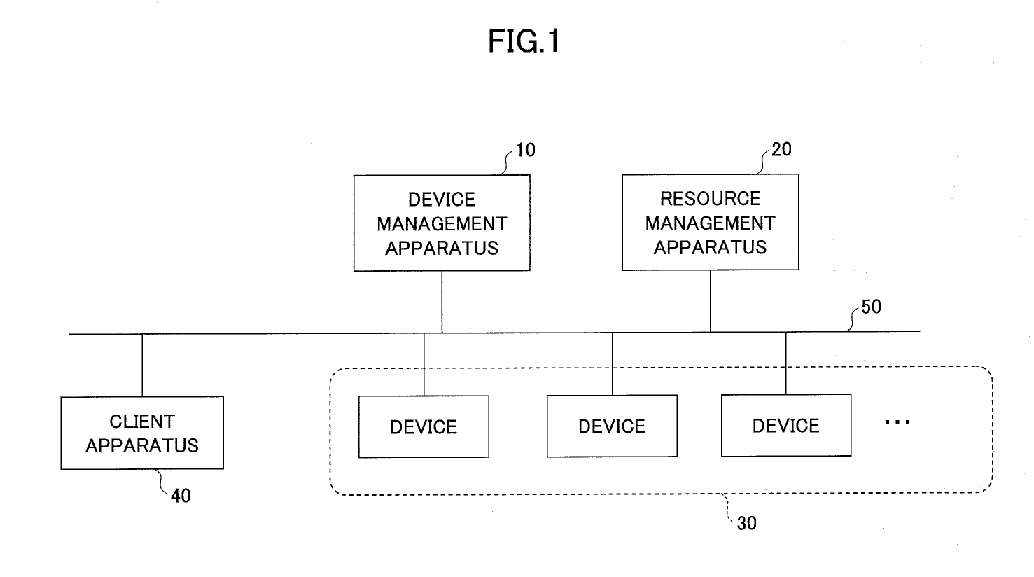

FIG. 1 is a view illustrating an example of a system structure of the embodiment. In FIG. 1, a device management apparatus 10, a resource management apparatus 20, a plurality of devices 30, a client apparatus 40 and the like are connected via a network 50 such as Local Area Network (LAN), Wide Area Network (WAN) or the like.

The device 30 is an image forming apparatus such as a multiple function processing machine, a copying machine, a scanner, a printer or the like, for example. Alternatively, the device 30 may be an electronic device other than the image forming apparatus such as a projector, an electronic white board, a video conference system, a digital camera, or the like.

The device management apparatus 10 is a computer capable of performing a batch setting process of setting information to each of the devices 30. The device management apparatus 10 stores information (hereinafter, referred to as “device information”) including attribution information of each of the devices 30, setting information set for each of the devices 30 and the like. The setting information includes values of setting items, programs or the like. In other words, in this embodiment, installation of a program in the device 30 is included in the setting process of setting information to the device 30.

The resource management apparatus 20 is a computer that manages resource information of each of the devices 30. The resource information is, for example, information necessary for a general resource management. In this embodiment, the resource information includes attribution information of the device 30 and information indicating a status of the devices 30 as a resource, in particular, information indicating a working condition of the device 30. The “information indicating a working condition” means information indicating whether the device is not used anymore. An example of the “information indicating a working condition” may be information indicating whether the device is disposed. Here, the resource management apparatus 20 may further manage resource information of resources other than the devices 30. For example, the resource management apparatus 20 may manage resource information of software or other resources.

The client apparatus 40 is a data processing apparatus that functions as a user interface to the device management apparatus 10 or the resource management apparatus 20. It means that a user inputs a request to the device management apparatus 10 or the resource management apparatus 20 via the client apparatus 40. As an example of the client apparatus 40, a Personal Computer (PC), a tablet terminal, a smartphone, a mobile phone or the like may be used.

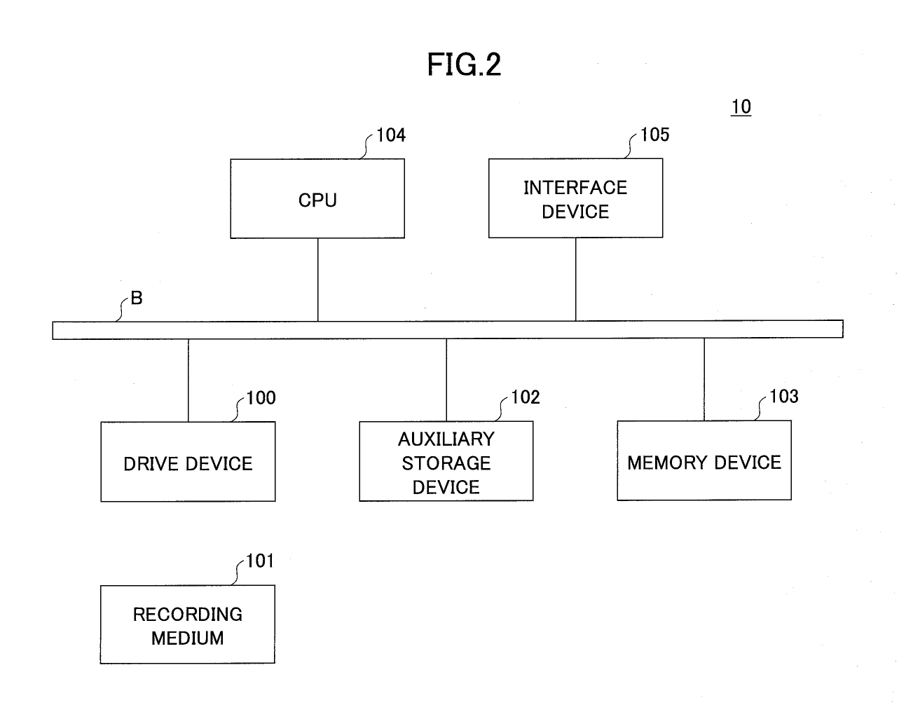

FIG. 2 is a view illustrating an example of a hardware structure of the device management apparatus 10 of the embodiment. The device management apparatus 10 includes a drive device 100, an auxiliary storage device 102, a memory device 103, a CPU 104, an interface device 105 and the like connected with each other via a bus B.

A program actualizing processes of the device management apparatus 10 is provided by a recording medium 101 such as a CD-ROM or the like. When the recording medium 101 in which the program is stored is set in the drive device 100, the program is installed in the auxiliary storage device 102 from the recording medium 101 via the drive device 100. However, the program may not be installed from the recording medium 101 and the program may be downloaded from another computer via the network 50. The auxiliary storage device 102 stores necessary files, data or the like, in addition to the installed program.

The memory device 103 reads out the program from the auxiliary storage device 102 and stores it upon receiving an instruction to activate the program. The CPU 104 performs functions of the device management apparatus 10 in accordance with the program stored in the memory device 103. The interface device 105 is used as an interface to connect to the network 50.

Here, the device management apparatus 10 may be composed by one or more computers. The resource management apparatus 20 may have a hardware structure that is the same as that illustrated in FIG. 2 and may be composed by one or more computers. Further, the device management apparatus 10 and the resource management apparatus 20 may be actualized by the same, one or more, computer(s).

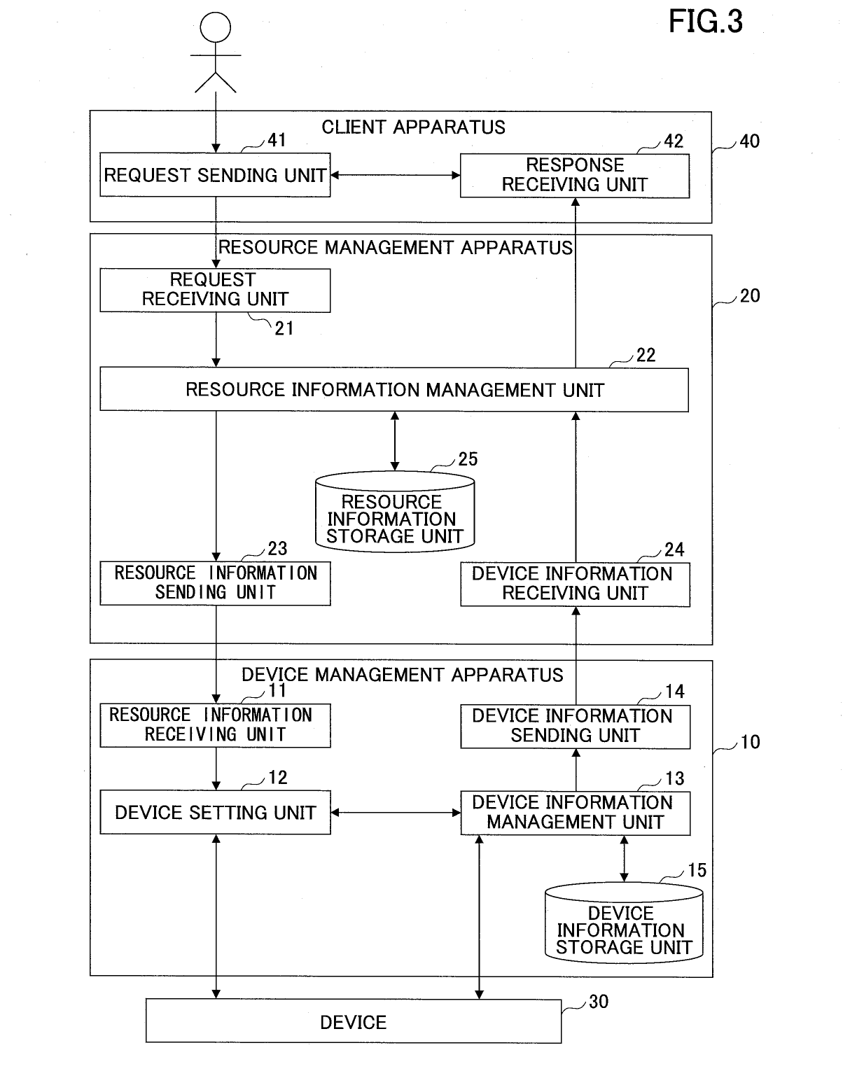

FIG. 3 is a view illustrating a functional structure of the apparatuses of the first embodiment.

The client apparatus 40 includes a request sending unit 41, a response receiving unit 42 and the like. The request sending unit 41 sends a request of processing in accordance with an operation by a user, input via an input device such as a mouse, a keyboard, a button, a touch panel or the like, to the resource management apparatus 20. The response receiving unit 42 receives a response including an executed result of the process executed in the resource management apparatus 20 in accordance with the request of processing. The response receiving unit 42 displays information included in the response on a display device such as a liquid crystal display or the like, for example.

The resource management apparatus 20 includes a request receiving unit 21, a resource information management unit 22, a resource information sending unit 23, a device information receiving unit 24 and the like. Each of these units is actualized by processes executed by a CPU of the resource management apparatus 20 by a program installed in the resource management apparatus 20. The resource management apparatus 20 further includes or uses a resource information storage unit 25. The resource information storage unit 25 may be actualized by an auxiliary storage device of the resource management apparatus 20, or a storage device or the like that is connected to the resource management apparatus 20 via the network 50.

The request receiving unit 21 receives the request of processing from the client apparatus 40. The resource information management unit 22 controls execution of a process in accordance with the request of processing from the client apparatus 40. For example, the resource information management unit 22 stores resource information in the resource information storage unit 25, obtains the resource information from the resource information storage unit 25 or the like. Further, the resource information management unit 22 sends back a response to the request of processing to the client apparatus 40.

The resource information storage unit 25 stores the resource information of each of the devices 30. The resource information sending unit 23 sends the resource information to the device management apparatus 10. The device information receiving unit 24 receives device information from the device management apparatus 10.

The device management apparatus 10 includes a resource information receiving unit 11, a device setting unit 12, a device information management unit 13, a device information sending unit 14 and the like. Each of these units is actualized by processes executed by the CPU 104 by a program installed in the device management apparatus 10. The device management apparatus 10 further includes or uses a device information storage unit 15. The device information storage unit 15 may be actualized by the auxiliary storage device 102, or a storage device or the like connected to the device management apparatus 10 via the network 50.

The resource information receiving unit 11 receives the resource information sent from the resource management apparatus 20. The device setting unit 12 sets setting information of the devices 30. The device information management unit 13 stores the device information in the device information storage unit 15, obtains the device information from the device information storage unit 15 or the like. The device information sending unit 14 sends the device information to the resource management apparatus 20. The device information storage unit 15 stores the device information of each of the devices 30.

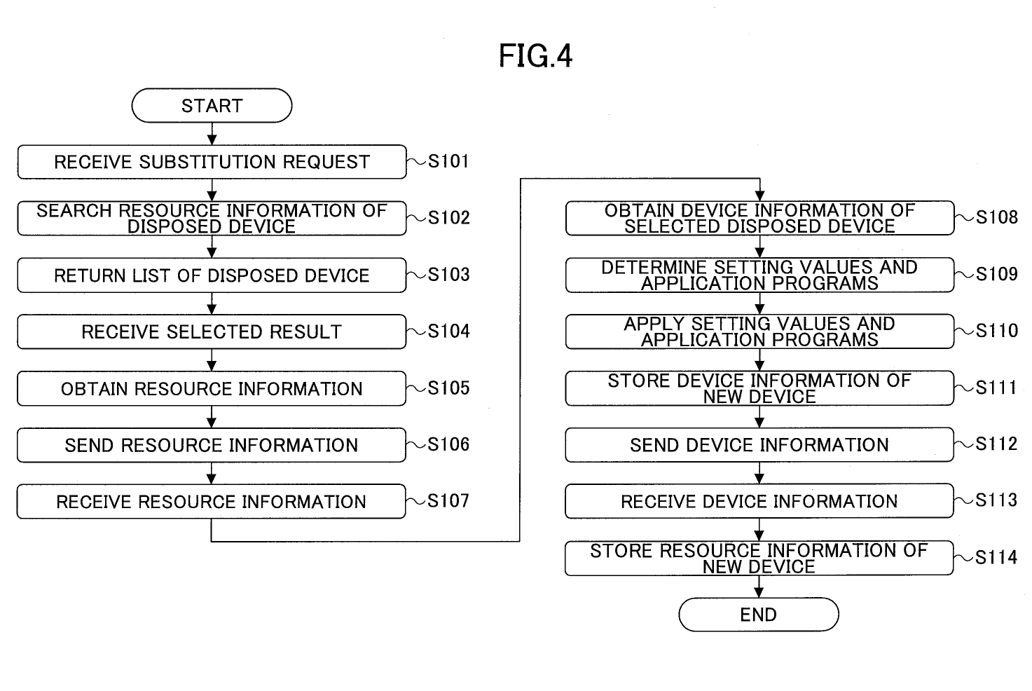

Process steps performed by the device management apparatus 10, the resource management apparatus 20 and the like are explained in the following. FIG. 4 is a flowchart for explaining an example of process steps performed by the device management apparatus 10 and the resource management apparatus 20 in the first embodiment.

First, upon accepting a substitution instruction of the device 30 from a user, the client apparatus 40 sends, in accordance with the instruction, a substitution request of the device 30 to the resource management apparatus 20. In step S101, the request receiving unit 21 of the resource management apparatus 20 receives the substitution request of the device 30 sent from the client apparatus 40.

For example, the client apparatus 40 may display a screen (hereinafter, referred to as a new device registration screen”) for registering resource information of a newly introduced (installed) device (hereinafter, referred to as a “new device 30”). At this time, the client apparatus 40 may accept an input of the substitution instruction of the device 30 via the new device registration screen.

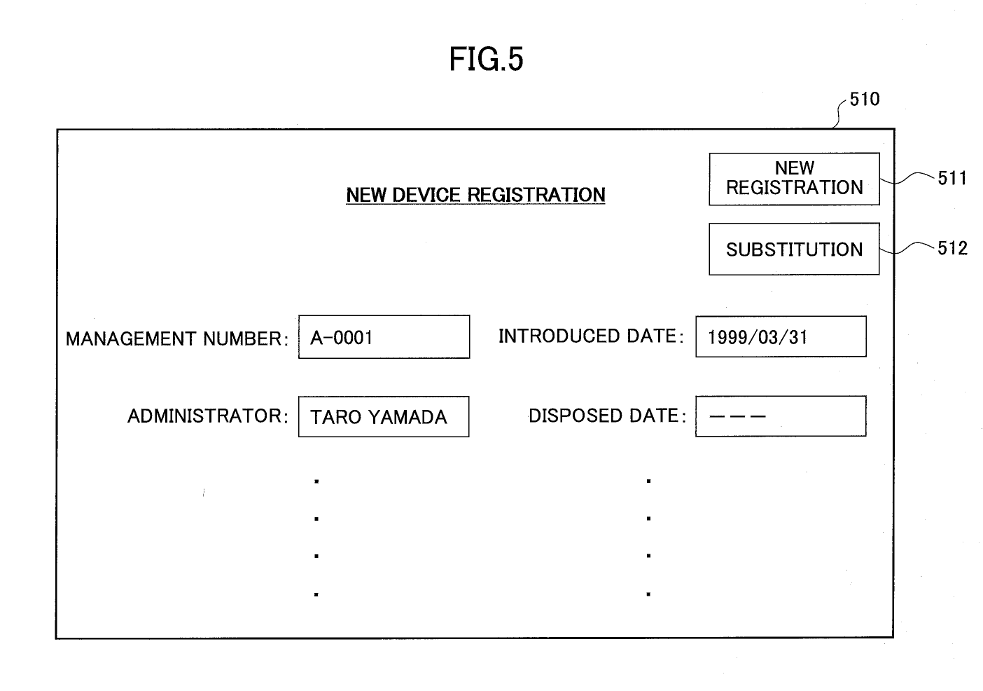

FIG. 5 is a view illustrating an example of a new device registration screen 510.

The new device registration screen 510 includes a new registration button 511, a substitution button 512, items composing the resource information and boxes for inputting corresponding values of the items and the like. Here, parts of items are omitted for an explanation purpose in FIG. 5. The items composing the resource information will be explained later.

The user can input the values of the items composing the resource information via the new device registration screen 510. The new registration button 511 is a button to have the client apparatus 40 accept an instruction to store resource information input in the new device registration screen 510 in the resource information storage unit 25.

The substitution button 512 is a button to have the client apparatus 40 accept the substitution instruction. Here, “substitution” means to substitute the previously installed device 30 with the new device 30. Further, in this embodiment, “substitution” includes a meaning that the setting information of the previously installed device 30, which is to be substituted, is taken over to the new device 30. In this embodiment, the previously installed device 30 that is to be substituted is referred to as a “disposed device 30” and the disposed device 30 is substituted by the new device 30.

Referring back to FIG. 4, in step S101, by pressing the substitution button 512, the substitution request of the device 30 is sent from the client apparatus 40 and received by the request receiving unit 21 of the resource management apparatus 20. Here, the substitution request of the device 30 includes the resource information of the new device 30 input in the new device registration screen 510. Further, the substitution request of the device 30 includes a registration request of the resource information of the new device.

The request receiving unit 21 stores the received resource information of the new device 30 in a memory device of the resource management apparatus 20, for example. Alternatively, the resource information may be stored in the resource information storage unit 25 at this time.

Subsequently, the resource information management unit 22 searches resource information of the disposed device 30 from the resource information storage unit 25 (S102).

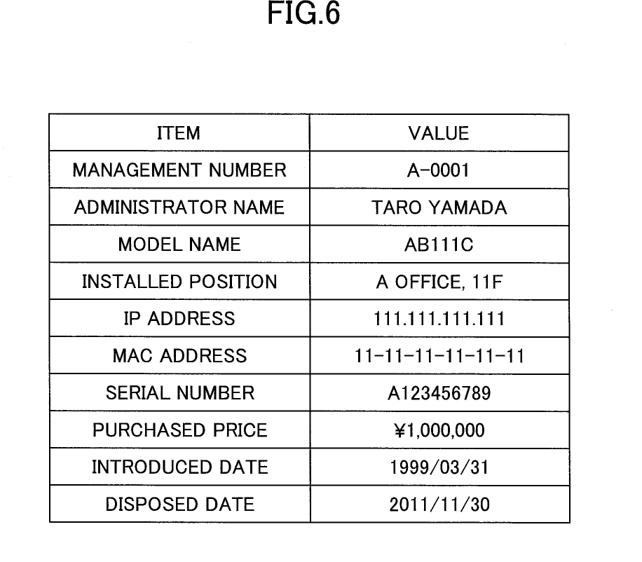

FIG. 6 is a view illustrating an example of a structure of the resource information. FIG. 6 illustrates an example of a structure of the resource information of one of the devices 30 (in other words, one of the records of the resource information storage unit 25). The resource information includes values for items composing the resource information, respectively. The items composing the resource information are, for example, management number, administrator name, model name, installed position, IP address, MAC address, serial number, purchased price, installed date (time), disposed date (time) and the like.

The “management number” is a number allocated to each of the devices 30 as the resource. The “administrator name” is name of an administrator of the device 30. The “model name” is model name of the device 30. The “installed position” is a place where the device 30 is installed. The “IP address”, the “MAC address” and the “serial number” are IP address, MAC address and serial number of the device 30, respectively. The “purchased price” is purchased price of the device 30. The “installed date” is date when the device 30 was introduced. The “disposed date” is date when the device 30 was disposed. Thus, for the device 30 that is still used (installed), in other words, the device 30 that is not disposed yet, a value of the disposed date is blank. Therefore, whether the device 30 is still used (installed) can be determined based on the disposed date. This means that the “disposed date” is an example of the information indicating a working condition of the device 30. Here, however, the resource information may further include an item such as a status or the like that directly indicates the working condition of the device 30. In the new device registration screen 510 illustrated in FIG. 5, values of the items, except the “disposed date” are input, for example.

Referring back to FIG. 4, in step S102, the resource information management unit 22 detects the resource information of the disposed devices 30, in other words, those devices 30 for each of which a value of the disposed date is included from the resource information storage unit 25. Then, the resource information management unit 22 returns a list of the detected resource information of the disposed devices 30 to the client apparatus 40 (S103).

Upon receiving the list, the response receiving unit 42 of the client apparatus 40 displays the list on the display device of the client apparatus 40. This means that the list of the disposed devices 30 that were already disposed is displayed on the client apparatus 40. Then, the user selects one of the disposed devices 30 to be substituted by the new device 30, which is designated via the new device registration screen 510 illustrated in FIG. 5, from the list. The request sending unit 41 of the client apparatus 40 sends identification data of the selected disposed device 30 to the resource management apparatus 20. The identification data of the disposed device 30 is information capable of specifying the selected disposed device 30, such as management number, IP address, MAC address, serial number or the like, for example. Here, alternatively, all of the resource information of the selected disposed device 30 may be sent.

The request receiving unit 21 of the resource management apparatus 20 receives the identification data of the disposed device 30 selected in the client apparatus 40 (S104). Subsequently, the resource information management unit 22 obtains the resource information of the selected disposed device 30 from the resource information storage unit 25 based on the identification data (S105). If all of the resource information of the selected disposed device 30 is sent from the client apparatus 40, this step can be omitted.

Subsequently, the resource information sending unit 23 sends the substitution request including the resource information of the selected disposed device 30 and the resource information of the new device 30 stored in the memory device of the resource management apparatus 20 or the like, to the device management apparatus 10 (S106).

The resource information receiving unit 11 of the device management apparatus 10 receives the substitution request including the resource information of the selected disposed device 30 and the resource information of the new device 30 (S107). Subsequently, the device information management unit 13 obtains device information of the selected disposed device 30 from the device information storage unit 15 (S108).

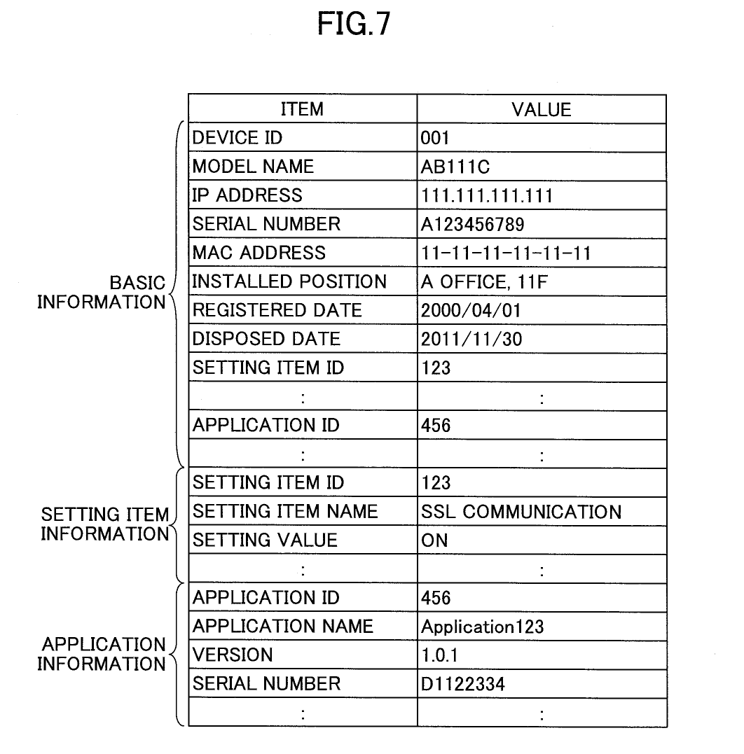

FIG. 7 is a view illustrating an example of a structure of the device information. FIG. 7 illustrates an example of a structure of the device information of one of the devices 30 (in other words, one of the records of the device information storage unit 15). The device information includes basic information, setting item information and application information.

The basic information is basic information of the device 30, and includes items such as device ID, model name, IP address, serial number, MAC address, installed position, registered date, disposed date, setting item ID, application ID and the like.

The “device ID” is identification data for identifying each of the devices 30 by the device management apparatus 10. The “model name”, the “IP address”, the “serial number”, the “MAC address” and the “installed position” have the same meaning as those of the resource information. The “registered date” is date when the device information is registered in the device information storage unit 15. For example, when the device management apparatus 10 detects the device 30 by searching the network 50, device information of the detected device 30 is automatically stored in the device information storage unit 15. The “disposed date” is date when an existence of the device 30 is not confirmed by the device management apparatus 10. For example, the device management apparatus 10 searches the devices 30 connected to the network 50 at a predetermined time-interval. For the devices 30 that are not detected for a predetermined period, or that are not continuously detected for a predetermined times, disposed date is stored.

The “setting item ID” is identification data of a setting item of the device 30. The basic information includes the number of “setting item ID” corresponding to the number of the setting items of the device 30. The “application ID” is identification data of an application program installed in the device 30. The basic information includes the number of application ID corresponding to the number of application programs installed in the device 30.

The “setting item information” is detailed information of the setting item of the device 30, and includes items such as setting item ID, setting item name, setting value and the like, for each of the setting items. The “setting item ID” is identification data of the setting item. The detailed information of the setting item is linked to the basic information by the “setting item ID”. The “setting item name” is name of the setting item. The “setting value” is a value set for the setting item.

The “application information” is detailed information of the application program installed in the device 30, and includes items such as application ID, application name, version, serial number and the like, for each of the application programs. The “application ID” is identification data of the application program. The detailed information of the application program is linked to the basic information by the “application ID”. The “application name” is name of the application program. The “version” is version of the application program. The “serial number” is serial number of the application program.

Referring back to FIG. 4, in step S108 device information having a serial number that is the same as the serial number included in the resource information of the selected disposed device 30, for example, is obtained from the device information storage unit 15. MAC address may be used instead of the serial number. Further, IP address may be used instead of the serial number under an environment where uniqueness of IP address is assured. Further a combination of two or more of the serial number, MAC address and IP address may be used.

Subsequently, the device setting unit 12 determines or specifies setting values, application programs and the like that are to be applied to the new device 30 indicated in the substitution request based on the device information of the disposed device 30 obtained in step S108 (S109). Basically, the device setting unit 12 determines to use setting values indicated by the setting item information included in the device information of the selected disposed device 30 as they are for setting values for the setting items of the new device 30. Further, basically, the device setting unit 12 determines application programs that are the same as those application programs indicated by the application information included in the device information of the selected disposed device 30 to be installed in the new device 30.

Subsequently, the device setting unit 12 applies the content determined or specified in step S109 to the new device 30 (S110). In other words, values that are the same as those of the selected disposed device 30 are set for the setting items of the new device 30. Further, application programs that are the same as those installed in the selected disposed device 30 are installed in the new device 30. The content of the application programs to be installed may be stored in the auxiliary storage device 102 of the device management apparatus 10. Alternatively, the content of the application programs to be installed may be stored in a storage device, not illustrated in the drawings, connected to the device management apparatus 10 via the network 50. Communication between the new device 30 may be performed based on IP address or the like included in the resource information indicated in the substitution request.

Subsequently, the device information management unit 13 stores device information of the new device 30 in the device information storage unit 15 based on an applied result by the device setting unit 12 (S111). For the basic information, the resource information indicated in the substitution request may be used, or alternatively, the device information management unit 13 may send an inquiry to the new device 30. Further, for the setting item information and the application information, data may be stored based on the applied result in step S109. In other words, the setting item information of the setting items for which the values are successfully set and application information of the application programs that are successfully installed may be stored.

Subsequently, the device information sending unit 14 sends the device information of the newly registered new device 30 to the resource management apparatus 20 (S112). The device information receiving unit 24 of the resource management apparatus 20 receives the device information (S113). Subsequently, the resource information management unit 22 of the resource management apparatus 20 stores the resource information of the new device 30 regarding the device information in the resource information storage unit 25 (S114). Here, the resource information that is to be stored in the resource information storage unit 25 may be the resource information input via the new device registration screen 510 illustrated in FIG. 5. Alternatively, values of the items that are common as those of the resource information may be extracted from the device information received in step S113, and the values of the resource information may be updated by the extracted values.

As described above, according to the first embodiment, settings that are the same as those of the disposed device 30 are automatically applied to the new device 30. Thus, a user only needs to perform a setting operation for a part different from that of the disposed device 30, for the new device 30. As a result, a setting operation to the new device 30 can be effectively performed.

Further, as the settings that are the same as those of the disposed device 30 are automatically applied to the new device 30, a possibility that functions usable in the disposed device 30 is also usable in the new device 30 can be increased.

Although an example in which the resource management apparatus 20 receives the substitution request from the client apparatus 40 is explained above, the substitution request may be received by the device management apparatus 10 and may be transferred to the resource management apparatus 20 by the device management apparatus 10.

Further, alternatively, the disposed device 30 substituted by the new device 30 may be automatically selected, not by the user, based on a commonality of the resource information. For example, the resource information management unit 22 may automatically select the disposed device 30 whose IP address, installed position, or the combination thereof matches the resource information of the new device 30, as one to be substituted.

Next, a second embodiment is explained. In the second embodiment, only points different from those of the first embodiment are explained. Thus, points not particularly mentioned may be the same as those explained in the first embodiment.

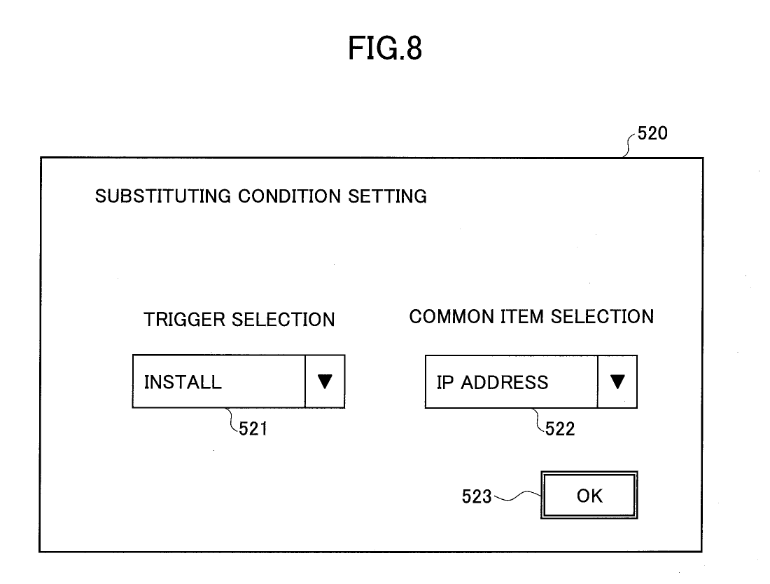

In the second embodiment, a substitution condition is previously set to the resource management apparatus 20 via the client apparatus 40 by the user. For example, a substitution condition setting screen illustrated in FIG. 8 is displayed on the client apparatus 40.

FIG. 8 is a view illustrating an example of a substitution condition setting screen 520. In FIG. 8, the substitution condition setting screen 520 includes list boxes 521 and 522 and the like. The list box 521 is a display component for selecting a trigger for substitution. In this embodiment, a trigger may be selected from trigger candidates including “Install”, “Move”, “Add”, “Change” and “Disposal” (hereinafter, referred to as “I, M, A, C and D”). FIG. 8 illustrates an example in which “install” is selected as the trigger for substitution. Here, “install” means installation of the device 30.

The list box 521 is a display component for selecting a common item, from the items composing the resource information, for which the value should be the same for the new device 30 and the disposed device 30. In FIG. 8, an example where “IP address” is selected is illustrated.

Thus, in FIG. 8, an example of a substitution condition is illustrated that “when a new installation of the device 30 (the new device 30) is detected, the disposed device 30 whose IP address is the same as that of the new device 30 is substituted by the new device 30”.

When an OK button 523 is pushed in the substitution condition setting screen 520, the request sending unit 41 of the client apparatus 40 sends a registration request of the substitution condition to the resource management apparatus 20. The registration request includes the substitution condition set in the substitution condition setting screen 520. The request receiving unit 21 of the resource management apparatus 20 stores the substitution condition in the auxiliary storage device of the resource management apparatus 20, for example.

Process steps of the second embodiment are explained under an assumption that the above described substitution condition is previously set.

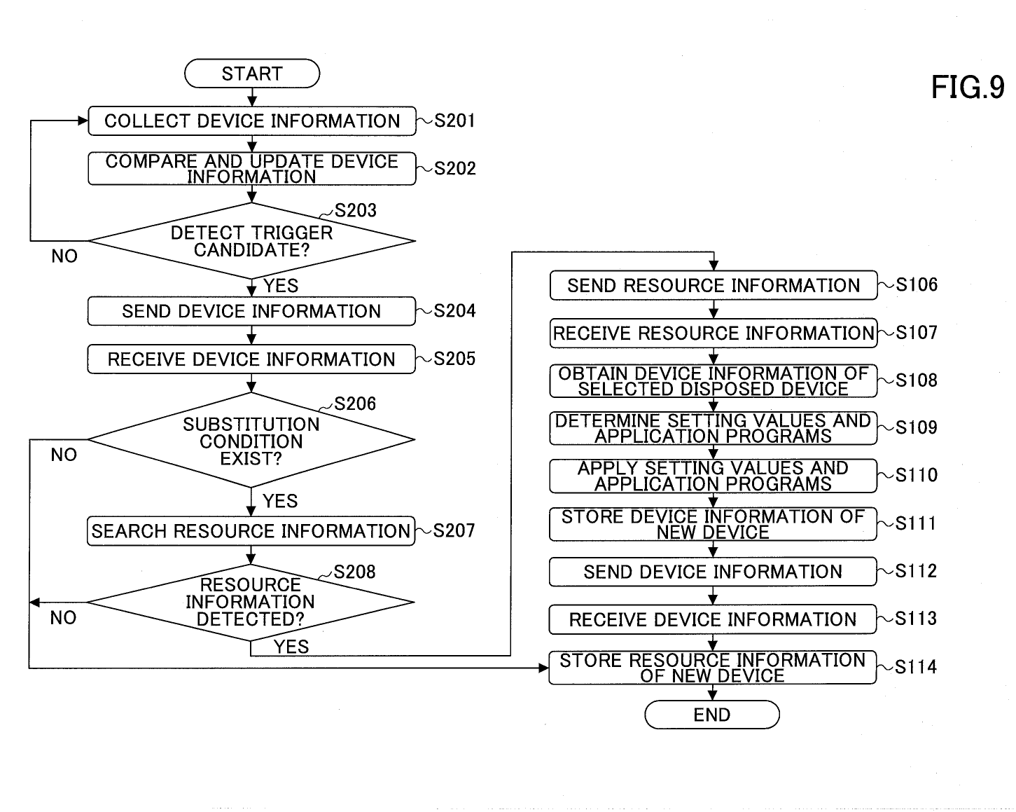

FIG. 9 is a flowchart for explaining an example of process steps performed by the device management apparatus 10 and the resource management apparatus 20 in the second embodiment. In FIG. 9, the same steps are given the same step numbers as FIG. 4, and explanations are not repeated.

The device information management unit 13 of the device management apparatus 10 periodically searches the devices 30 connected to the network 50, and collects device information of each of the detected devices 30, for example (S201). Thus, up-to-date device information of each of the devices 30 connected to the network 50 can be periodically collected.

Subsequently, the device information management unit 13 compares a list of the collected device information and a list of the device information stored in the device information storage unit 15, and updates the device information storage unit 15 for different parts (S202). For example, if there exists device information that is not stored in the device information storage unit 15 in the collected device information, the device information is stored in the device information storage unit 15. This means that the installation of the device 30 of the device information is detected as well. Further, if there is device information that is stored in the device information storage unit 15 but is not included in the collected device information, and the number of times or the period that the device information is not detected exceeds a predetermined value, this means that the device 30 regarding the device information is not connected to the network 50 anymore. In other words, this means that the disposal of the device 30 regarding the device information is detected as well. Thus, current date is stored for the disposed date of the device information. Further, if there is a difference between the collected device information and the device information stored in the device information storage unit 15 for the same device 30, the difference is updated by the collected device information.

Subsequently, the device information management unit 13 determines whether either of the trigger candidates (I, M, A, C and D) is detected for the device 30 by comparing the device information (S203). For example, the device information management unit 13 determines whether either of installation of the new device 30, movement of the device 30, addition of a function to the device 30, change of setting of the device 30, disposal of the device 30 and the like is detected.

When either of the trigger candidates is detected (YES in S203), the device information sending unit 14 sends the device information of the device 30 for which either of the trigger candidates is detected and the detected trigger candidate as an event, to the resource management apparatus 20 (S204). The device information receiving unit 24 of the resource management apparatus 20 receives the device information and the event (S205). For example, when installation of the new device 30 is detected, the event may be information indicating that the device 30 regarding the device information is newly installed. At this time, the information received here includes a meaning of a registration request of resource information of the device 30 regarding the device information.

Subsequently, the resource information management unit 22 of the resource management apparatus 20 determines an existence of the substitution condition that matches the received event (S206). For example, when the event is “install”, the resource information management unit 22 determines whether a substitution condition in which “install” is set as a trigger is stored in the auxiliary storage device.

When the corresponding substitution condition is stored (YES in S206), the resource information management unit 22 searches resource information of the disposed device 30 that satisfies the substitution condition (S207). In other words, the resource information management unit 22 searches resource information of the disposed device 30 in which a value of the common item set in the substitution condition matches that of the device information received in step S205. For example, when the substitution condition is as illustrated in FIG. 8, resource information of the disposed device 30 in which a value of the IP address is the same as that included in the device information received in step S205.

When the corresponding resource information is detected (YES in S208), the resource information management unit 22 sends a substitution request including the detected resource information of the disposed device 30 and the device information received in step S205 (device information of the new device 30, for example) to the device management apparatus 10 (S106).

The following steps are the same as those explained with reference to FIG. 4. As a result, for example, setting information of the disposed device 30 whose IP address is the same as that of the new device 30 is applied to the new device 30 installation of which is detected.

Here, in step S206, when the corresponding substitution condition does not exist (NO in S206), or when the corresponding resource information is not detected in step S207 (NO in S208), step S114 is performed.

In step S114, resource information of the device is stored in the resource information storage unit 25 based on the device information of the installed device.

As described above, according to the second embodiment, the setting information of the disposed device 30 is automatically applied to the new device 30 in accordance with a detection of a trigger such as installation of the new device 30 by the device management apparatus 10. As a result, a setting operation to the new device 30 can be effectively performed.

Further, the disposed device 30 whose setting information is to be taken over to the new device 30 is selected based on a commonality in attribution of the new device 30. Thus, a possibility that the setting information of the appropriate disposed device 30 is taken over to the new device 30 can be increased.

According to the embodiments, a setting operation for a device can be effectively performed.

Here, in this embodiment, the computer system including the device management apparatus 10 and the resource management apparatus 20 is an example of the data processing system. The device information storage unit 15 is an example of a first storage unit or a storage unit. The resource information storage unit 25 is an example of a second storage unit or a storage unit. The device information management unit 13 is an example of an obtaining unit and a detecting unit. The device setting unit 12 is an example of a setting unit. The device management apparatus 10 and the resource management apparatus 20 is an example of a data processing apparatus. The resource management apparatus 20 is an example of a storage device. The request receiving unit 21 or the device information receiving unit 24 is an example of a receiving unit. The resource information sending unit 23 is an example of a requesting unit.

The following embodiment may be included.

A data processing apparatus including: a storage unit that stores information indicating a working condition of each device; a receiving unit that receives a registration request to the storage unit for a second device; a requesting unit that requests to set setting information of a first device for which information indicating that the device is not used is stored in the storage unit for the second device, to another data processing apparatus that stores setting information of each device.

A non-transitory computer-readable recording medium having recorded thereon a program that causes a computer connected to a storage device that stores information indicating a working condition of each device via a network, to execute steps including: an obtaining step of obtaining setting information of a first device for which information indicating that the device is not used is stored in the storage device from a storage unit that stores setting information of a plurality of devices; and a setting step of setting the obtained setting information for a second device.

A non-transitory computer-readable recording medium having recorded thereon a program that causes a computer to execute steps including: a receiving step of receiving a registration request to store information of a second device in a storage unit that stores information indicating a working condition of each device; and a requesting step of requesting to set setting information of a first device for which information indicating that the device is not used is stored in the storage unit for the second device, to another data processing apparatus that stores setting information of each device.

The individual constituents of the device management apparatus 10, the resource management apparatus 20 and the client apparatus 40 may be embodied by arbitrary combinations of hardware and software, typified by a CPU of an arbitrary computer, a memory, a program loaded in the memory so as to embody the constituents illustrated in the drawings, a storage unit for storing the program such as a hard disk, and an interface for network connection. It may be understood by those skilled in the art that methods and devices for the embodiment allow various modifications.

Although a preferred embodiment of the data processing system, the method of data processing and the data processing apparatus has been specifically illustrated and described, it is to be understood that modifications may be made therein without departing from the spirit and scope of the invention as defined by the claims.

The present invention is not limited to the specifically disclosed embodiments, and numerous variations and modifications and modifications may be made without departing from the spirit and scope of the present invention.

The present application is based on and claims the benefit of priority of Japanese Priority Application No. 2012-257478 filed on Nov. 26, 2012, the entire contents of which are hereby incorporated by reference.

What is claimed is:

1. A data processing system comprising:
a first storage unit that stores setting information of a plurality of devices;
a second storage unit that stores information indicating a working condition of each device;
an obtaining unit that obtains setting information of a first device for which information indicating that the device is not used is stored in the second storage unit, from the first storage unit; and
a setting unit that sets the obtained setting information for a second device.

2. The data processing system according to claim 1,
wherein the first storage unit and the second storage unit store attribution information of each device, respectively, and
wherein the setting unit sets the obtained setting information for the second device at least a part of whose attribution information matches that of the first device.

3. The data processing system according to claim 1, further comprising:
a detecting unit that detects new installation of a device, and
wherein the setting unit sets the obtained setting information for the second device which is detected to be newly installed by the detecting unit.

4. A method of data processing performed by a computer connected to a storage device that stores information indicating a working condition of each device via a network, comprising:
an obtaining step of obtaining setting information of a first device for which information indicating that the device is not used is stored in the storage device from a storage unit that stores setting information of a plurality of devices; and
a setting step of setting the obtained setting information for a second device.

5. The method of data processing system according to claim 4,
wherein the storage device and the storage unit store attribution information of each device, respectively, and
wherein in the setting step, the obtained setting information is set for the second device at least a part of whose attribution information matches that of the first device.

6. The method of data processing system according to claim 4, further comprising:
a detecting step of detecting new installation of a device, and
wherein in the setting step, the obtained setting information is set for the second device which is detected to be newly installed in the detecting step.

7. A data processing apparatus connected to a storage device that stores information indicating a working condition of each device via a network, comprising:
a storage unit that stores setting information of each device;
an obtaining unit that obtains setting information of a first device for which information indicating that the device is not used is stored in the storage device, from the storage unit; and
a setting unit that sets the obtained setting information for a second device.
